(19) United States
(12) Patent Application Publication
(10) Pub. No.: US 2026/0242581 A1
(43) Pub. Date: Aug. 20, 2026

(54) AUTOMOTIVE COMPOSITE RESIN COMPOSITION INCLUDING BIOMASS-BASED MATERIAL, AUTOMOTIVE PART INCLUDING SAME, AND VEHICLE INCLUDING AUTOMOTIVE PART

(71) Applicants: Hyundai Motor Company, Seoul (KR); Kia Corporation, Seoul (KR); DY Deokyang Co., Ltd., Ulsan (KR); HDC Hyundai Engineering Plastics Co., Ltd., Dangjin-si (KR)

(72) Inventors: Boo Youn An, Hwaseong-si (KR); In Soo Han, Hwaseong-si (KR); Kwon Mo Koo, Dangjin-si (KR); Sung Bok Kwak, Anyang-si (KR); eun seob Shin, Yongin-si (KR); Jae Yong Lee, Anyang-si (KR)

(73) Assignees: Hyundai Motor Company, Seoul (KR); Kia Corporation, Seoul (KR); DY Deokyang Co., Ltd., Ulsan (KR); HDC Hyundai Engineering Plastics Co., Ltd., Dangjin-si (KR)

(21) Appl. No.: 19/291,352

(22) Filed: Aug. 5, 2025

(30) Foreign Application Priority Data
Feb. 18, 2025 (KR) 10-2025-0020516

(51) Int. Cl. C08L 23/12; C08K 7/14

(52) U.S. Cl. CPC C08L 23/12; C08K 7/14; C08L 2205/025; C08L 2205/035; C08L 2205/16

(57) ABSTRACT

The present disclosure relates to an automotive composite resin composition including a biomass-based material and exhibiting improved impact performance, an automotive part including the automotive composite resin composition, and a vehicle including the automotive part.

### CROSS-REFERENCE TO RELATED APPLICATIONS

This present application claims the benefit of priority to Korean Patent Application No. 10-2025-0020516, filed on Feb. 18, 2025, in the Korean Intellectual Property Office, the entire contents of which are incorporated herein by reference in their entireties.

### FIELD

The present disclosure relates to an automotive composite resin composition including a biomass-based material and exhibiting improved impact performances, an automotive part including the automotive composite resin composition, and a vehicle including the automotive part.

### BACKGROUND

In recent years, the automotive industry has increasingly prioritized not only lightweight design but also other factors such as impact performance, thermal stability, and the utilization of eco-friendly materials. This multifaceted focus reflects a concerted effort to mitigate environmental impacts while enhancing vehicle safety and performance. A notable aspect of this initiative involves the active incorporation of biomass-based materials, which offer sustainable alternatives to traditional petroleum-derived components. By integrating these environmentally friendly substances into automotive manufacturing, the industry aims to reduce its carbon footprint and promote a more circular economy.

Biomass encompasses organic materials derived from living organisms such as plants, animals, and microorganisms, and it offers the significant advantage of being a renewable resource that can effectively replace fossil fuels. Comprising a diverse range of components-including cellulose, lignin, hemicellulose, fats, and proteins-biomass finds extensive applications across energy production, chemical manufacturing, and the creation of high-performance materials. As society increasingly prioritizes sustainability and environmental protection, biomass-based materials are drawing considerable attention as viable alternatives for minimizing greenhouse gas emissions and reducing dependence on fossil resources.

Cellulose nanofiber (CNF) and lignin are two exemplary biomass materials that demonstrate enhanced physical properties and are increasingly finding applications in the automotive industry. CNF, a natural polymer characterized by its high mechanical strength and low density, is being utilized in automotive components such as dashboards, panels, and seats. However, excessive incorporation of CNF can adversely affect flowability and fluidity during the manufacturing process, thereby complicating injection molding. On the other hand, lignin, which bolsters the structural strength of wood fibers, presents significant potential as a carbon resource in composite materials. Nevertheless, an overreliance on lignin can compromise the impact strength and durability of automotive parts, underscoring the need for careful balance in material selection to optimize performance and sustainability in automotive applications.

While biomass-based materials present notable advantages as eco-friendly and renewable alternatives, they also come with several drawbacks that can limit their applicability. For instance, the hydrophilic nature of biomass can result in moisture absorption, which subsequently diminishes the mechanical strength and durability of composite materials. This moisture sensitivity, in conjunction with their vulnerability to microorganisms, light, and heat exposure, renders them less suitable for high-performance applications. Moreover, in comparison to traditional materials, biomass-based options often exhibit relatively lower impact performance, particularly in terms of impact strength. Thus, there is a need to develop material formulations and compositions that incorporate biomass constituents to enhance mechanical properties.

### SUMMARY

The present disclosure is directed to providing an eco-friendly automotive composite resin composition incorporating biomass, which exhibits improved impact performance and thermal properties, as well as an automotive part including the composition and a vehicle including the automotive part.

An aspect of the present disclosure provides an automotive composite resin composition, the automotive composite resin composition including, based on the total composition, 20 to 40 parts by weight of a polyolefin-based resin, and 25 to 30 parts by weight of a biomass-based material.

In embodiments, the biomass-based material includes one or more of cellulose nanofiber (CNF), polyhydroxyalkanoate (PHA), lignin, bio-based polyethylene (PE) or any combination thereof.

Another aspect of the present disclosure provides an automotive part including an automotive composite resin composition according to various aspects of the present disclosure.

Still another aspect of the present disclosure provides a vehicle including the automotive parts according to various aspects of the present disclosure.

The automotive composite resin composition according to the present disclosure includes a biomass-based material in an amount of at least 25 wt. % based on the total weight, thereby being environmentally friendly and meeting the certification requirements for bio-based products.

In embodiments, the automotive composite resin composition according to the present disclosure includes the biomass-based material, it exhibits improved flowability or fluidity, allowing for smooth injection molding.

In embodiments, the automotive part including the automotive composite resin composition according to the present disclosure exhibits improved impact resistance.

In embodiments, the automotive part according to the present disclosure includes a biomass-based material, and exhibits improved strength, modulus of elasticity, and thermal properties.

### DETAILED DESCRIPTION

Furthermore, the terms used in the detailed description, including technical or scientific terms, have the same meaning as would be commonly understood by a person skilled in the art in the technical field of the present disclosure, unless specifically defined otherwise. It will be further understood that terms in common usage should also be interpreted as is customary in the relevant art and not in an idealized or overly formal sense unless expressly so defined herein.

Furthermore, these terms such as “first,” “second,” and other numerical terms, are used only to distinguish one element from another element. These terms are generally only used to distinguish one element from another. For example, without departing from the scope of the present disclosure, the first component may be referred to as the second component, and similarly, the second component may be referred to as the first component.

The terminology used herein is used for the purpose of describing particular exemplary embodiments only and is not intended to be limiting. A singular form includes a plural form if there is no clearly opposite meaning in the context. In the following description, the terms “include,” “comprise,” “have,” and the like designate the existence of features, steps, elements, and combinations thereof, but should not be understood as precluding the existence or addition of one or more other features, steps, elements, or combinations thereof.

In embodiments, an automotive composite resin composition of the present disclosure includes a polyolefin-based resin and a biomass-based material.

According to an embodiment of the present disclosure, the polyolefin-based resin includes polypropylene (PP). In embodiments, the polypropylene (PP) has a flowability of 50 to 150 g/10 min.

Polypropylene has similar properties to polyethylene (PE), and in embodiments, has a higher melting point, improved transparency, and improved flexibility compared to polyethylene. Additionally, in embodiments, polypropylene has improved mechanical properties, such as tensile strength and compressive strength, as well as improved thermal properties, including a low coefficient of thermal expansion and a high heat distortion temperature.

In embodiments, the automotive composite resin composition according to the present disclosure includes the polyolefin-based resin in an amount of 20 to 40 parts by weight based on the total composition.

In embodiments, the automotive composite resin composition of the present disclosure includes the biomass-based material.

Biomass is a collective term for organic materials derived from living organisms, such as plants, animals, and microorganisms. It may be chemically or biologically synthesized for use as a polymer material and may be environmentally friendly.

In embodiments, the biomass-based material according to the present disclosure includes one or more of cellulose nanofiber (CNF), polyhydroxyalkanoate (PHA), lignin, bio-based polyethylene (PE), or any combination thereof.

In embodiments, the automotive composite resin composition according to the present disclosure includes the biomass-based material in an amount of 25 to 30 parts by weight based on the total composition.

In embodiments, the automotive composite resin composition according to the present disclosure includes the biomass-based material in an amount of at least 25 wt. % based on the total weight, thereby meeting the certification requirements for bio-based products.

The certification for bio-based products is globally conducted in accordance with the ASTM D6866 test standard, and each country operates a bio-based product certification system based on the biomass content.

In South Korea, certification is granted to products that include biomass in an amount of at least 25 wt. % based on the total weight, in accordance with the ASTM D6866 test. In particular, transparent and foamed products are certified when they include biomass in an amount of at least 15 wt. % based on the total weight. In addition, bio-based synthetic resin products are certified when they include biomass in an amount of at least 25 wt. % based on the total weight.

However, bio-based products in South Korea differ slightly from international standard specifications in that they exclude the use of natural polymers such as starch, cellulose, and wood flour.

That is, although the certification criteria for bio-based materials vary by country, a product is internationally certified as a bio-based product when it includes biomass-based material in an amount of 20 to 25 wt. % or more based on the total weight. Accordingly, in embodiments, the automotive composite resin composition according to the present disclosure meets the certification requirements for bio-based products based on international standard specifications.

In embodiments, the biomass-based material of the present disclosure includes cellulose nanofiber (CNF).

Cellulose nanofiber (CNF) is a material derived from natural resources, exhibiting high strength and light weight, which may contribute to the weight reduction of the automotive composite resin composition.

In an embodiment of the present disclosure, the automotive composite resin composition includes cellulose nanofiber in an amount of 7 to 13 parts by weight based on the total weight.

When the automotive composite resin composition of the present disclosure includes cellulose nanofiber in an amount of less than 7 parts by weight based on the total weight, the improvement in the mechanical properties of the entire composition, in embodiments, is insignificant. When the automotive composite resin composition of the present disclosure includes cellulose nanofiber in an amount exceeding 13 parts by weight based on the total weight, flowability and fluidity may deteriorate, which, in embodiments, is disadvantageous for injection molding.

In an embodiment of the present disclosure, the automotive composite resin composition includes cellulose nanofiber in an amount of 20 to 35 parts by weight per 100 parts by weight of the biomass-based material.

In embodiments, during the manufacturing of the automotive composite resin composition of the present disclosure, cellulose nanofiber is introduced as a 50% masterbatch, ensuring the above-mentioned content ratio in the final composition. In this context, the 50% masterbatch means that cellulose nanofiber is included in the masterbatch at a concentration of 50%, and the previously mentioned parts by weight range of cellulose nanofiber may correspond to half of the actual parts by weight introduced.

That is, the content of cellulose nanofibers actually introduced to prepare the automotive composite resin composition of the present disclosure, in embodiments, is twice the specified parts by weight range.

The biomass-based material of the present disclosure includes polyhydroxyalkanoates (PHA).

Polyhydroxyalkanoates (PHA) are biodegradable polymers synthesized by microorganisms in nature and provide improved thermal stability.

In an embodiment of the present disclosure, the automotive composite resin composition includes polyhydroxyalkanoates in an amount of 3 to 7 parts by weight based on the total weight.

When the automotive composite resin composition of the present disclosure includes polyhydroxyalkanoates in an amount of less than 3 parts by weight based on the total weight, the improvement in thermal properties, in embodiments, is insignificant. When the automotive composite resin composition of the present disclosure includes polyhydroxyalkanoates in an amount of less than 7 parts by weight based on the total weight, the mechanical strength of the overall composition, in embodiments, is reduced.

In an embodiment of the present disclosure, the automotive composite resin composition includes polyhydroxyalkanoates in an amount of 10 to 20 parts by weight per 100 parts by weight of the biomass-based material.

The biomass-based material of the present disclosure includes lignin.

Lignin is a natural polymer that binds with cellulose in wood to enhance structural strength and exhibits improved heat and chemical resistance.

In an embodiment of the present disclosure, the automotive composite resin composition includes lignin in an amount of 7 to 13 parts by weight based on the total weight.

When the automotive composite resin composition of the present disclosure includes lignin in an amount of less than 7 parts by weight based on the total composition, the content of biomass-based materials decreases, making it difficult to meet the previously described bio-based product certification standards. When the automotive composite resin composition of the present disclosure includes lignin in an amount exceeding 13 parts by weight based on the total composition, impact performance and environmental test performance may deteriorate significantly.

In an embodiment of the present disclosure, the automotive composite resin composition includes lignin in an amount of 20 to 35 parts by weight per 100 parts by weight of the biomass-based material.

Bio-based polyethylene (PE) is polyethylene produced from ethanol derived from biomass (e.g., sugarcane) rather than existing petroleum-based sources. It may be environmentally friendly and exhibit the same physical properties as existing petroleum-based polyethylene.

In an embodiment of the present disclosure, the automotive composite resin composition includes the bio-based polyethylene in an amount of 3 to 10 parts by weight based on the total weight.

When the automotive composite resin composition of the present disclosure includes the bio-based polyethylene in an amount of less than 3 parts by weight based on the total composition, in embodiments, does not sufficiently secure mechanical properties. When the automotive composite resin composition of the present disclosure includes the bio-based polyethylene in an amount exceeding 10 parts by weight based on the total composition, the performance of polyethylene, in embodiments, is excessively pronounced, potentially disrupting the overall balance of biomass-based materials.

In an embodiment of the present disclosure, the automotive composite resin composition includes the bio-based polyethylene in an amount of 15 to 30 parts by weight per 100 parts by weight of the biomass-based material.

In embodiments, the automotive composite resin composition of the present disclosure further includes a stiffness reinforcing agent. In one example, the stiffness reinforcing agent includes one or more of cellulose fiber, basalt fiber, glass fiber, carbon fiber, or any combination thereof. The above materials are exemplary, and the type of stiffness reinforcing agent in the present disclosure is not limited thereto.

In an embodiment of the present disclosure, the automotive composite resin composition includes the stiffness reinforcing agent in an amount of 10 to 20 parts by weight based on the total composition.

When the automotive composite resin composition of the present disclosure includes the stiffness reinforcing agent in an amount of less than 10 parts by weight based on the total composition, in embodiments, it is difficult to achieve high stiffness performance. When the automotive composite resin composition of the present disclosure includes the stiffness reinforcing agent in an amount exceeding 20 parts by weight based on the total composition, flowability and fluidity, in embodiments, deteriorates, and achieving weight reduction is difficult.

Meanwhile, the automotive composite resin composition of the present disclosure further includes an impact modifier. In one example, the impact modifier includes one or more of an α-olefin copolymer having a carbon number ranging from 3 to 8, a terpolymer, styrene-butadiene rubber (SBR), ethylene-octene elastomer (EOE), styrene-ethylene-butylene-styrene (SEBS), or any combination thereof. The above materials are exemplary, and the type of impact modifier in the present disclosure is not limited thereto.

In an embodiment of the present disclosure, the automotive composite resin composition includes the impact modifier in an amount of more than 10 parts by weight and less than 30 parts by weight based on the total composition.

When the automotive composite resin composition of the present disclosure includes the impact modifier in an amount of 10 parts by weight or less based on the total composition, the improvement in impact performance, in embodiments, is insignificant. When the automotive composite resin composition of the present disclosure includes the impact modifier in an amount exceeding 30 parts by weight based on the total composition, thermal properties, in embodiments, deteriorate.

In embodiments, the automotive composite resin composition of the present disclosure further includes a compatibilizer. The compatibilizer can enhance the compatibility between polymers with different properties, preventing deterioration of physical properties.

In one example, the compatibilizer is be a polyolefin-based resin including a furan group. The compatibilizer includes the furan group in an amount of 0.3 to 2 parts by weight per 100 parts by weight of polyolefin.

However, this is merely an example, and the type of compatibilizer in the present disclosure is not limited thereto.

In embodiments, the compatibilizer has a flowability of 50 to 150 g/10 min.

In embodiments, the automotive composite resin composition according to the present disclosure further includes additional additives. In the present disclosure, the additional additives include one or more of an antioxidant, a light stabilizer, a colorant, a lubricant, an antistatic agent, or any combination thereof. In embodiments, the additional additives are commercially available additives, and are not limited to a specific type. Any additive that can be incorporated into the automotive composite resin composition to improve its physical properties may be used as an additional additive in the present disclosure.

An automotive part according to the present disclosure includes the automotive composite resin composition described in the various examples above.

A vehicle according to the present disclosure includes the automotive part described in the various examples above. Therefore, it may be environmentally friendly while having improved mechanical properties.

Hereinafter, the present disclosure will be described in more detail by means of examples. However, the following examples and experimental examples are provided merely to describe the present disclosure in more detail, and the scope of the present disclosure is not limited by the following examples and experimental examples.

### EXAMPLES AND COMPARATIVE EXAMPLES

Examples and Comparative Examples with the compositions listed in Table 1 below were prepared. The specific compositions used in the automotive parts of Examples 1 and 2 and Comparative Examples 1 to 6 are as follows.

A polypropylene resin was used as the polyolefin-based resin (hereinafter denoted as PP in Table 1). As the stiffness reinforcing agent, glass fibers with an average diameter of 10 μm and surface-treated with polysiloxane were used. As an impact modifier, a combination of ethylene-octene elastomer and styrene-ethylene-butylene-styrene elastomer, both thermoplastic elastomers, was used. As the compatibilizer, a maleic anhydride-grafted modified polypropylene (PP) was used. As the additional additives, an antioxidant and a weather stabilizer, etc. were used.

TABLE 1

| | Composition Range | | | | | | | | |
|---|---|---|---|---|---|---|---|---|---|
| | | | | | | Stiffness | | | |
| | | Biomass-based Material | | | | Reinforcing | Impact | | Additional |
| Category | PP | CNF | PHA | Lignin | Bio-PE | Agent | Modifier | Compatibilizer | Additives |
| Example 1 | 20 | 10 | 5 | 10 | 5 | 20 | 25 | 3 | 2 |
| Example 2 | 30 | 10 | 5 | 10 | 5 | 10 | 25 | 3 | 2 |
| Comparative | 20 | 10 | 5 | 10 | 15 | 10 | 25 | 3 | 2 |
| Example 1 | | | | | | | | | |
| Comparative | 20 | 15 | — | 10 | 5 | 20 | 25 | 3 | 2 |
| Example 2 | | | | | | | | | |
| Comparative | 15 | 10 | 5 | 10 | 5 | 20 | 30 | 3 | 2 |
| Example 3 | | | | | | | | | |
| Comparative | 35 | 10 | 5 | 10 | 5 | 20 | 10 | 3 | 2 |
| Example 4 | | | | | | | | | |
| Comparative | 40 | 10 | — | — | — | 20 | 25 | 3 | 2 |
| Example 5 | | | | | | | | | |
| Comparative | 30 | 20 | — | — | — | 20 | 25 | 3 | 2 |
| Example 6 | | | | | | | | | |

### Experimental Example

The physical properties of the automotive parts according to Examples 1 and 2 and Comparative Examples 1 to 6 were assessed. The melt flow index (MFI), tensile strength, flexural strength, flexural modulus, impact strength, and heat distortion temperature of the automotive parts in the Examples and Comparative Examples were measured.

The assessment of each physical property was conducted according to the following tests and conditions.
1) Melt Flow Index (MFI): ISO 1133-1 (2.16 kg@230° C.)
2) Tensile Strength: ISO 527 (50 mm/min)
3) Flexural Strength and Flexural Modulus: ISO 178 (2 mm/min)
4) Impact Strength: ISO 180 (2.94 J)
5) Heat deflection temperature (HDT):

The assessment results of the physical properties for Examples 1 and 2 and Comparative Examples 1 to 6 are shown in Table 2 below.

TABLE 2

| | Physical Properties | | | | | |
|---|---|---|---|---|---|---|
| | Melt | | | | | Heat |
| | Flow | | | | | Distortion |
| | Index | Tensile | Flexural | Flexural | Impact | Temper- |
| | (g/10 | Strength | Strength | Modulus | Strength | ature |
| Category | min) | (MPa) | (MPa) | (MPa) | (kJ/m²) | (° C.) |
| Example 1 | 15 | 41.5 | 55 | 2650 | 23 | 155 |
| Example 2 | 17 | 36.7 | 50 | 2450 | 17 | 152 |
| Comparative | 18 | 32.7 | 42 | 2050 | 21 | 139 |
| Example 1 | | | | | | |
| Comparative | 5 | 38.3 | 49 | 2430 | 15 | 148 |
| Example 2 | | | | | | |
| Comparative | 17 | 30.5 | 38 | 1990 | 27 | 135 |
| Example 3 | | | | | | |
| Comparative | 25 | 35.5 | 51 | 2550 | 7 | 149 |
| Example 4 | | | | | | |
| Comparative | 28 | 38 | 48 | 2330 | 30 | 151 |
| Example 5 | | | | | | |
| Comparative | 10 | 40 | 52 | 2510 | 10 | 153 |
| Example 6 | | | | | | |

Referring to Table 2, it can be seen that the automotive parts in Examples 1 and 2 exhibit improved performance compared to those in Comparative Examples 1 to 6.

First, the heat distortion temperature of the automotive part in Comparative Example 1 is 139° C., indicating inferior thermal properties compared to those in Examples 1 and 2. This result is attributed to the high bio-based polyethylene (Bio-PE) content in the automotive part of Comparative Example 1. Table 2 confirms that the automotive parts in the Examples exhibit greater stability in high-temperature environments. This result reaffirms the importance of achieving an appropriate balance or formulation of biomass-based materials.

Comparative Example 2 exhibited a lower melt flow index (MFI) than Examples 1 and 2. This result is attributed to the increased cellulose nanofiber (CNF) content in Comparative Example 2. Table 2 confirms that the automotive parts in the Examples exhibit improved processability due to a well-balanced biomass-based material composition.

In Comparative Example 3, the impact modifier was excessively included compared to Examples 1 and 2, resulting in inferior thermal properties (heat distortion temperature: 135° C.). In contrast, in Comparative Example 4, the impact modifier was included in a lower amount compared to Examples 1 and 2, resulting in inferior impact performances (impact strength: 7 KJ/m²).

In Comparative Examples 5 and 6, no biomass-based materials were included except for cellulose nanofiber. Therefore, Comparative Examples 5 and 6 did not include biomass-based materials in an amount exceeding 25 wt. % based on the total composition and thus failed to meet the certification criteria for bio-based products. Furthermore, Comparative Example 5 exhibited low tensile and flexural strength, while Comparative Example 6 exhibited poor flowability and impact strength.

Through the above experiments, it was confirmed that the automotive parts in Examples 1 and 2 included a certain amount or more of biomass-based materials, thereby meeting the certification criteria for bio-based products. In addition, the automotive parts in Examples 1 and 2 secured all the improved physical properties required for application to automotive parts through an appropriate composition ratio of biomass-based materials.

Although the present disclosure has been described with reference to the embodiments, various changes or modifications can be made by those skilled in the art. In this regard, it will be understood by one of ordinary skill in the art that various changes in form and details may be made therein without departing from the scope of the disclosure. Therefore, the disclosed embodiments should be considered in a descriptive sense only and not in a limiting sense. The scope of the disclosure is defined not by the detailed foregoing description but by the following claims, and all differences within the scope will be construed as being included in the disclosure.

What is claimed is:

1. An automotive composite resin composition, comprising, based on the total weight:
(i.) 20 to 40 parts by weight of a polyolefin-based resin;
(ii.) 25 to 30 parts by weight of a biomass-based material, and
wherein the biomass-based material includes one or more of cellulose nanofiber (CNF), polyhydroxyalkanoate (PHA), lignin, bio-based polyethylene (PE), or any combination thereof.

2. The automotive composite resin composition of claim 1, wherein the polyolefin-based resin comprises polypropylene (PP) with a flowability of 50 to 150 g/10 min.

3. The automotive composite resin composition of claim 1, wherein the cellulose nanofiber (CNF) is included in an amount of 7 to 13 parts by weight based on the total weight.

4. The automotive composite resin composition of claim 1, wherein the cellulose nanofiber (CNF) is included in an amount of 20 to 35 parts by weight per 100 parts by weight of the biomass-based material.

5. The automotive composite resin composition of claim 1, wherein the polyhydroxyalkanoate (PHA) is included in an amount of 3 to 7 parts by weight based on the total weight.

6. The automotive composite resin composition of claim 1, wherein the polyhydroxyalkanoate (PHA) is included in an amount of 10 to 20 parts by weight per 100 parts by weight of the biomass-based material.

7. The automotive composite resin composition of claim 1, wherein the lignin is included in an amount of 7 to 13 parts by weight based on the total weight.

8. The automotive composite resin composition of claim 1, wherein the lignin is included in an amount of 20 to 35 parts by weight per 100 parts by weight of the biomass-based material.

9. The automotive composite resin composition of claim 1, wherein the bio-based polyethylene (PE) is included in an amount of 3 to 10 parts by weight based on the total weight.

10. The automotive composite resin composition of claim 1, wherein the bio-based polyethylene (PE) is included in an amount of 15 to 30 parts by weight per 100 parts by weight of the biomass-based material.

11. The automotive composite resin composition of claim 1, further comprising 10 to 20 parts by weight of a stiffness reinforcing agent based on the total weight, wherein the stiffness reinforcing agent comprises one or more of cellulose fibers, basalt fibers, glass fibers, carbon fibers, or any combination thereof.

12. The automotive composite resin composition of claim 1, further comprising an impact modifier in an amount of more than 10 parts by weight and less than 30 parts by weight based on the total weight, wherein the impact modifier comprises one or more of an α-olefin copolymer having a carbon number of 3 to 8, a terpolymer, styrene-butadiene rubber (SBR), ethylene-octene elastomer (EOE), styrene-ethylene-butylene-styrene (SEBS), or any combination thereof.

13. An automotive part comprising the automotive composite resin composition of claim 1.

14. A vehicle comprising the automotive part of claim 13.
